(19) United States
(12) Patent Application Publication
(10) Pub. No.: US 2004/0148830 A1
(43) Pub. Date: Aug. 5, 2004

(54) Magnetic vehicle sign, kit, and method for selling a vehicle

(76) Inventor: Victor Baskerville, Potomac Falls, VA (US)

Correspondence Address: Sonya C. Harris, PO Box 2607, Fairfax, VA, 22031, US

(21) Appl. No.: 10/357,206

(22) Filed: Feb. 4, 2003

(51) Int. Cl. G09F 7/04

(52) U.S. Cl. 40/600

(57) ABSTRACT

A magnetic signboard kit adapted for advertising a vehicle for sale is disclosed. The signboard, formed of a ferromagnetic particulate impregnated sheet of rubber or a polymeric, contains three fields for indicia on a face surface, the first permanently imprinted with message, such as “FOR SALE, and two with blank backgrounds adapted to receive a hand printed message regarding the vehicle being sold. The complete kit consists of at least one signboard, at least one marker and cleaning solution.

### BACKGROUND OF THE INVENTION

1. Field of the Invention

The present invention relates to advertising signs which may individualized by a user. More particularly, the invention comprises a magnetic sign designed for mounting on a vehicle in order to provide information about the vehicle being offered for sale.

2. Description of the Prior Art

U.S. Pat. No. 6,159,577, issued to Adrian W. Pynenburg, et al., on Dec. 12, 2000, presents a MAGNETIC MODIFIABLE SIGN SYSTEM wherein a sign board is formed of a plastic substrate upon which a base message (e.g. a product name and description) is printed in magnetic inks. Variable messages (e.g. a current price) may be displayed on the signboard by the placement of individual alphanumeric characters and/or distinctive symbols or graphics formed from flexible magnetic material. Magnetic attraction between the ink of the base message of the sign board and the various magnetic elements of the variable message maintain the variable message on the sign board.

Pynenburg discloses a MAGNETIC MODIFIABLE SIGN SYSTEM in U.S. Pat. No. 5,852,890, issued on Dec. 29, 1998, which is quite similar to his above referenced system. However, in this earlier disclosure, the magnetic attraction of the sign board is provided a metallic sheet, as opposed to the magnetic of the later embodiment of U.S. Pat. No. 6,159,577.

A MAGNETIC SIGN MOUNT, consisting of a plastic clip with a magnetic strip mounted to the lower, interior surface of both the front and rear leaves, is disclosed in U.S. Pat. No. 4,703,575, issued to Israel Diamond no Nov. 3, 1987. The exterior surface of the front and/or rear leaf may contain a permanent message, or the exterior of the front leaf may include flanges for holding removable messages in place. The exterior of the rear leaf is intended for mounted, as on the interior of a storefront window. The magnetic strips interior of the leaves maintain tight closure of the clip and maintain a placard in suspension from the clip.

Shigeo Sano, et al., disclose a MAGNETICALLY ATTACHABLE SIGN in U.S. Pat. No. 4,663,874, issued on May 12, 1987, a flexible magnetic sign formed of ferromagnetic particulate impregnated sheet of rubber or plastic with a ribbed back surface.

A MAGNETIC SIGN warning of a wet floor is disclosed in U.S. Pat. No. Des. 394,459, issued to Vincent P. Horner on May 19, 1998. The present invention differs from Horner in that Horner includes no provisions for the user to inscribe individualized information onto the sign.

None of the above inventions and patents, taken either singly or in combination, is seen to describe the instant invention as claimed.

### SUMMARY OF THE INVENTION

The present invention fulfills the need for a means of advertising a motor vehicle for sale by an owner without the typical obstruction of vision by paper signs taped in a window or windows. The present invention consists of a signboard formed of flexible rubber or polymeric material impregnated with ferromagnetic particulate which adhere the signboard to the metal body of a vehicle by magnetic attraction. The face of the signboard is preprinted with a permanent message, such as “FOR SALE”, with space allocated for additional user inscribed information, such as a contact phone number and information about the vehicle. The signboard of the invention is treated to removably accept a hand written message applied with a dry erase, water soluble, alcohol soluble or permanent pen, as desired for individual applications. The inventive signboard is intended for distribution with a marker of the appropriate type, and cleaning materials, as applicable.

Accordingly, it is a principal object of the invention to provide a magnetic, preprinted, signboard having space for additional hand written information about an item, such as a vehicle, being offered for sale.

It is another object of the invention to provide a signboard which is magnetic for attachment to a metallic surface.

It is a further object of the invention to provide a signboard upon which information may be removably inscribed by hand.

Still another object of the invention is to provide a signboard as a part of a kit which also includes a marker and cleaner for removing hand inscribed information.

An additional object of the invention is to provide a signboard and an associated kit which is easy to use.

It is again an object of the invention to provide a signboard and an associated kit which is economical to purchase and use Yet another object of the invention is to provide a signboard which is non-obstructive of a vehicle driver's view.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a front environmental perspective view of the signboard of the present invention.

FIG. 2 is a diagrammatic sketch of the kit of the present invention.

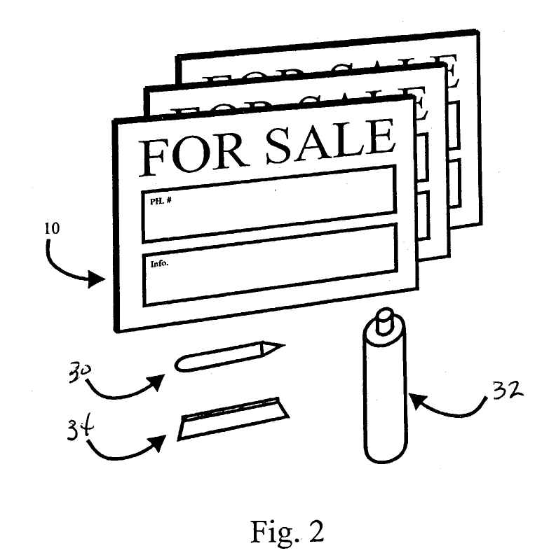

### DETAILED DESCRIPTION OF THE PREFERRED EMBODIMENTS

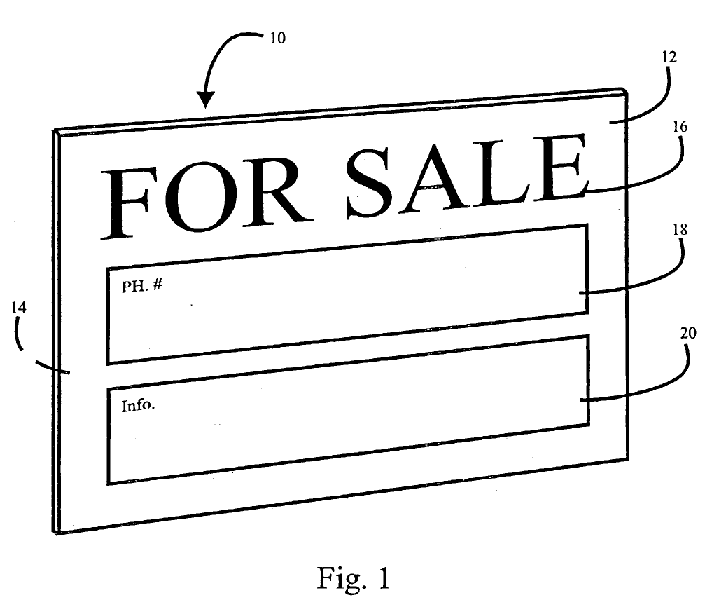

Referring to FIG. 1, the signboard 10 of the present invention consists of a flexible sheet of rubber or polymeric material impregnated with ferromagnetic particulate which adhere the signboard 10 to the metal body of a vehicle by magnetic attraction. Magnetic signboards are well known in the art, as in U.S. Pat. No. 4,663,874, cited hereinabove, therefore they will not be further described herein.

Signboard 10 has a face side 12 and a back side 14, with face side 12 of signboard 10 typically being printed with a background of a substantially solid color. Upon this solid color face side 12, are three separate fields 16, 18, 20 of indicia. Field 16 is typically inscribed with the words “FOR SALE”, or the like, in a color contrasting that of the background, such that field 16 may be easily read from a distance. Field 18 is a substantially blank field, typically white in color. Inscribed on a portion of field 18, generally the upper left corner, is words “PH. #”, “Phone”, or the like, with the balance of the field available for the user to add a contact phone number for the sale. Field 20 is, likewise, a substantially blank field, also typically white in color. Inscribed on a portion of field 20, also generally the upper left corner, is “Info.”, “Information”, or the like, with the balance fo the filed available for the user to add information about the vehicle, such as model year, asking price, mileage, or the like. It would be evident to one skilled in the art that while the white of fields 18, 20 being the natural color of the base material of signboard 10 with the background color of face side 12 printed therearound, would be preferable, a white overprint of the background color could be a viable alternative.

A marking pen 30 is used by the user to inscribe information into fields 16, 18. It would be evident to one skilled in the art that while marking pens 30 are available in dry erase, water soluble, alcohol soluble and permanent types, the use of either alcohol soluble or permanent would be preferable since exposure to the elements would cause dry erase and water soluble inks to run and blur the information.

Kit 100 consists of at least one signboard 10 and at least one marking pen 30. While a single signboard 10 allows display of the sales message on a single side or rear of a vehicle, additional signboards 10 allow display of the sales message on more than one side and/or rear of the vehicle at the same time, thereby reaching more of an audience, simultaneously. Kit 100 may also include a container of cleaning fluid 32 and a cleaning implement 34.

It is to be understood that the present invention is not limited to the embodiments described above, but encompasses any and all embodiments within the scope of the following claims.

What is claimed is:

1. A magnetic vehicle sign kit for the sale of a vehicle comprising:
a magnetic vehicle signboard further comprising:
a sheet formed of a flexible material having a face side and a back side, said sheet being impregnated with ferromagnetic particulate, said ferromagnetic particulate adapted to adhere said signboard to the metal body of a vehicle, said face side being printed with a background of substantially a solid color,
a first field of printed indicia, said printed indicia being of a color contrasting the color of said background,
a second field for indicia, and
a third field for indicia; and
marking means for applying user determined indicia in said second field and said third field.
cleaning means for removing said user determined indicia from said second field and said third field.

2. A magnetic vehicle sign kit for the sale of a vehicle, as defined in claim 1, wherein said flexible material comprises one of the group of rubber and a polymeric.

3. A magnetic vehicle sign kit for the sale of a vehicle, as defined in claim 2, wherein said second field and said second field are of a light color.

4. A magnetic vehicle sign kit for the sale of a vehicle, as defined in claim 3, wherein said background color is printed around said second field and said third field, the natural color of said material of said flexible forming said light color of said second field and said third field.

5. A magnetic vehicle sign kit for the sale of a vehicle, as defined in claim 3, wherein said face side is solidly overprinted with said background color and said light color of said second field and said third field are printed over said background color.

6. A magnetic vehicle sign kit for the sale of a vehicle, as defined in claim 3, said indicia of said first field comprise the words “FOR SALE”.

7. A magnetic vehicle sign kit for the sale of a vehicle, as defined in claim 3, wherein said second field is substantially devoid of indicia.

8. A magnetic vehicle sign kit for the sale of a vehicle, as defined in claim 7, wherein, in the upper left corner of said second field is printed indicia comprising the words “PH. #”.

9. A magnetic vehicle sign kit for the sale of a vehicle, as defined in claim 7, wherein, in the upper left corner of said second field is printed indicia comprising the words “Phone #”.

10. A magnetic vehicle sign kit for the sale of a vehicle, as defined in claim 7, wherein, in the upper left corner of said third field is printed indicia comprising the word “Info.”.

11. A magnetic vehicle sign kit for the sale of a vehicle, as defined in claim 7, wherein, in the upper left corner of said third field is printed indicia comprising the word “Information”.

12. A magnetic vehicle sign kit for the sale of a vehicle, as defined in claim 1, wherein said marking means comprises a marking pen.

13. A magnetic vehicle sign kit for the sale of a vehicle, as defined in claim 12, wherein said marking pen contains an alcohol soluble ink.

14. A magnetic vehicle sign kit for the sale of a vehicle, as defined in claim 12, wherein said marking pen contains an insoluble ink.

15. A magnetic vehicle sign kit for the sale of a vehicle, as defined in claim 13, wherein said kit further comprises cleaning means for removing said user determined indicia from said second field and said third field.

16. A magnetic vehicle sign kit for the sale of a vehicle, as defined in claim 15, wherein said cleaning means comprises a container of isopropyl alcohol.

17. A magnetic vehicle sign kit for the sale of a vehicle, as defined in claim 16, wherein said cleaning means further comprises a cleaning implement.

18. A method for selling a vehicle comprising the steps of:
using a kit comprising:
at least one magnetic vehicle signboard further comprising:
a sheet of flexible material having a face side and a back side, said sheet being impregnated with ferromagnetic particulate, said ferromagnetic particulate adapted to adhere said signboard to the metal body of a vehicle, said face side being printed with a background of a substantially solid color
a first field of printed indicia comprising the words “FOR SALE”, said printed indicia being of a color contrasting the color of said background,
a second field for indicia, said second field being of a light color and substantially devoid of preprinted indicia, with the characters “PH #” printed in an upper left corner of said second field, and
a third field for indicia, said third field being of a light color and substantially devoid of preprinted indicia, with the characters “Info.” printed in an upper left corner of said third field; and at least
a marking pen; and
inscribing a contact telephone number in said second field of each of said at least one magnetic vehicle signboard, and
inscribing information about a vehicle being offered for sale in said third field of each of said at least one magnetic vehicle signboard, and
affixing each of said at least one magnetic vehicle signboard to a side of a vehicle being offered for sale.
